(19) United States
(12) Patent Application Publication
(10) Pub. No.: US 2009/0006251 A1
(43) Pub. Date: Jan. 1, 2009

(54) UNIVERSAL ROLLOVER ACCOUNT

(75) Inventors: Staci M. HAASE, Tampa, FL (US); Christopher P. CRACCHIOLO, Old Bridge, NJ (US); Alec S. WILKINS, Salt Lake City, UT (US); Mark C. KECK, New York, NY (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc., New York, NY (US)

(21) Appl. No.: 11/770,367

(22) Filed: Jun. 28, 2007

(51) Int. Cl. G06Q 40/00; G06Q 50/00

(52) U.S. Cl. 705/40

(57) ABSTRACT

A system, method and computer program product for allowing users to set-up a separate stored value account on their transaction instrument to fund expenses. The stored value account, referred to herein as a Universal Rollover Account (URA) system, can be funded by check, an Automated Clearing House (ACH), or by charging another card or transaction instrument. Users and/or card-members will be given access to a web portal to manage their Universal Rollover Accounts, including changing their funding method, adding or withdrawing funds, and changing their configuration such that the URA bucket can come before or after other funding accounts in a payment hierarchy.

### BACKGROUND OF THE INVENTION

1. Field of the Invention

The present invention generally relates to a system and method for setting up and operating a stored value account on a multi-purse transaction instrument to carry out financial transactions.

2. Related Art

In the present day healthcare scenario, how consumers pay for healthcare expenditures is changing. Presently, less than 20% of consumer healthcare payments is through use of “plastic,” which includes debit cards, charge cards, and credit cards. This percentage is expected to grow by over 10% in five years to approximately 30% by 2010.

Another fundamental change that is expected to occur in the healthcare industry is the increase in use of more focused healthcare plans like consumer-directed healthcare plans (“CDHPs”), which offer tax advantages to employers who offer such plans and, for some CDHPs, to employees as well. The shift towards CDHPs, while providing tax and other benefits to employers and/or employees, also entails significant administrative costs borne by the employers. Among many limitations of conventional CDHPs is the fact that a member enrolled in such CDHPs has to maintain different accounts to find various transactions. Further, this entails the use of different transaction instruments for different accounts and different transactions.

Given the foregoing, what is needed is a system, method and computer program product for integrating the use and transfer of funds from various tax-advantaged and non-tax-advantaged accounts for healthcare and other purchases into a single universal account and thereby further ease bad debt and collection issues faced by providers.

### SUMMARY OF THE INVENTION

The present invention meets the above-mentioned needs by providing a system, method and computer program product for members to set up a universal stored value account that draws funds from various tax-advantaged and non-tax-advantaged accounts to fund expenses, like healthcare expenses, for example. The stored value account, referred to herein as a Universal Rollover Account (URA) system, URA bucket or just URA, can be funded by a check, an Automated Clearing House (ACH), or by charging another card or a transaction instrument.

The term “Universal Rollover Account” generally refers to a functionality of a payment account that “rolls over” funds from various primary and/or secondary accounts. Further, the term “Rollover” defines this functionality as the ability to transfer funds into a payment account, and depositing back any unused funds from the payment account back into the various primary and/or secondary accounts.

Users and/or card-members can be given access to a web portal to manage their Universal Rollover Accounts, including changing their funding method, adding or withdrawing funds, and changing their configuration such that the URA bucket can be tapped before or after other funding accounts in a payment hierarchy. Further, this solution provides card-members with the flexibility of loading additional funds from various funding sources including other transaction instruments, onto their URA transaction instrument to use for spending. This generally results in more choices and flexibility to the card-members and can be seen as a “pseudo line-of-credit”.

Various embodiments of the present invention provide a system, method and computer program product for setting up a URA via a single transaction instrument to fund various expenses. The various embodiments may also include performing one or more of the aforementioned functions independently and in any order, as per the need.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings, in which like reference numbers indicate identical or functionally similar elements. Additionally, the left-most digit of a reference number identifies the drawing in which the reference number first appears.

FIG. 1 is a block diagram showing a general flow of funds from various accounts into the Universal Rollover Account (URA), according to an embodiment of the present invention;

FIG. 2 is a flowchart illustrating an exemplary enrollment process for a member to enroll in the URA, according to another embodiment of the present invention may be implemented;

FIG. 3 is a flowchart illustrating an exemplary process by which a member enrolled in the URA may manage the account;

FIG. 4 illustrates a flowchart describing an exemplary scenario in which a member may use the present invention;

FIG. 5 is a block diagram of an exemplary computer system for implementing the present invention.

### DETAILED DESCRIPTION

### I. Overview

The detailed description of exemplary embodiments of the invention herein makes reference to the accompanying drawings and figures, which show the exemplary embodiments by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. It will be apparent to a person skilled in the pertinent art that this invention can also be employed in a variety of other applications. Thus, the detailed description herein is presented for purposes of illustration only and not of limitation. For example, the steps recited in any of the method or process descriptions may be executed in any order and are not limited to the order presented.

For the sake of brevity, conventional data networking, application development and other functional aspects of the systems (and components of the consumer operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The present invention is described herein with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The present invention is now described in more detail herein in terms of the above exemplary system, method and computer program product. This is for convenience only and is not intended to limit the application of the present invention. In fact, after reading the following description, it will be apparent to one skilled in the relevant art(s) how to implement the following invention in alternative embodiments.

According to various embodiments of the invention, a member can be a patient, an employee of a firm, a dependent of a member and/or an employee, or any other entity that can operate a transaction instrument and an account associated with the transaction instrument. For example, by means of the present invention, an employee, who is provided a healthcare benefit by an employer, will have the ability to set-up a Universal Rollover Account (URA) through an already existing membership with a financial institution (via an employer, for example). Such a pre-existing membership may be to a healthcare plan. The employee or member may add funds into the URA from various tax-advantaged and/or non-tax-advantaged funding sources or accounts. Further, the member may prioritize an order of selection of funding sources by means of a web-portal, for example. Once enrolled into a URA account, a member can monitor or manage his or her account through the web-portal. For example, if an employee (who is also a member) chooses to set-up this rollover account, he or she will need to provide the financial institution associated with the URA some information including name, a card number, a card expiry date, a card identification number (CID), and other related information. For example, and not by way of limitation, the CID number could be a 4-digit number. An employee, who is not yet a member with the financial institution managing the URA may first apply for such a membership even before he or she decides to enroll for the URA.

To load funds into the URA, a member can use any conventional financial instrument. For example, funds can be loaded by writing a check or by charging a pre-existing debit or credit card. Other forms of loading funds can easily be contemplated by those skilled in the art. It is worth noting that the type of financial instrument used for loading funds is not a limiting factor to the present invention.

As a further example, an employee can send a check written on a non-tax-advantaged account to the financial institution to load funds into the URA. For this particular example, deposit slips may be provided to the member when checks are used as a transaction instrument.

Similarly, an Automated Clearing House (ACH) may be used to transfer funds into the URA from another bank account held by the member. As is well known to one skilled in the art, any transfer or funds can be made through a web-portal, a telephone banking operation, by mail, or through a personal visit to a financial institution by the member. Further, such transfers can be carried out at a regular frequency determined by the member or on a random basis, as per individual needs of the member.

According to another embodiment of the present invention, the member can load funds to the URA by using a credit and/or a debit card. Such a credit/debit card may be another transaction instrument associated with a financial institution that is also maintaining the URA or it could be associated with a separate financial institution. The member can specify an exact amount of funds to be transferred from the credit/debit card into the URA. The transferred funds would be available for use by the member after some pre-determined time. Alternatively, a member may use funds in the URA to pay for credit card expenses via a web-portal, for example.

Funds can be withdrawn from the URA at any time through initiation of an ACH transfer to another bank account, or by requesting the financial institution for a balance refund. Transaction history of any initiated and/or completed transaction can be stored, for example, on a web-portal for future use by the member and/or the financial institution.

### II. System

As will be appreciated by one of ordinary skill in the art, URA system 100 may be embodied as a customization of an existing system, an add-on product, upgraded software, a stand-alone system, a distributed system, a method, a data processing system, a device for data processing, and/or a computer program product. Accordingly, URA system 100 or parts thereof may take the form of an entirely software embodiment, an entirely hardware embodiment, or an embodiment combining aspects of both software and hardware. Furthermore, URA system 100 may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

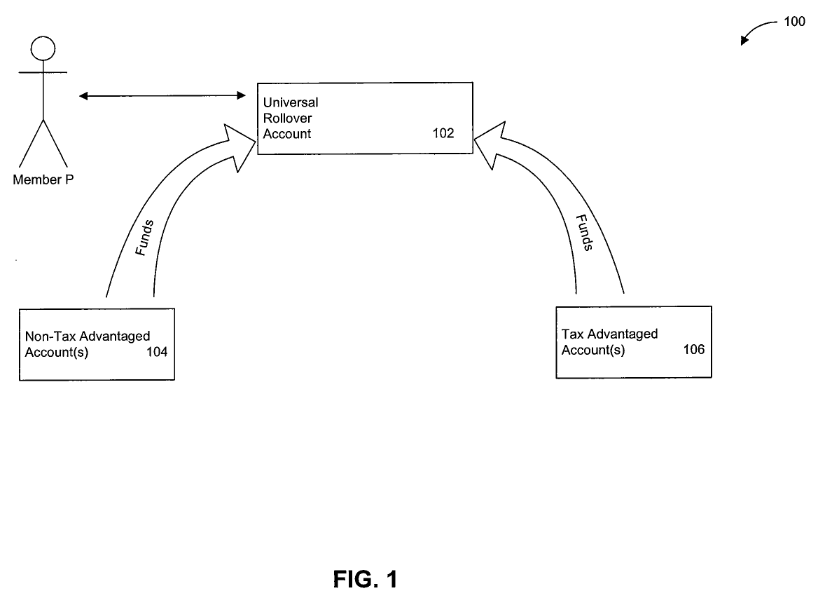

FIG. 1 shows an exemplary scenario for a Universal Rollover Account (URA) system 100 where a member P enrolled in a Universal Rollover Account (URA) 102 can have funds drawn from non-tax-advantaged account(s) 104 and/or from tax-advantaged account(s) 106. Examples of non-tax-advantaged account(s) 104 are a checking account, a line of credit account, an Automated Clearing House (ACH) account, a savings account, a debit card account, and the like. In other words, member P does not receive any federal, state or local tax benefits on funds in such non-tax-advantaged account(s) 104. Such accounts are occasionally referred to as “secondary accounts” for URA 102. Examples of tax-advantaged account(s) 106 are a Healthcare Savings Account (HSA), a Flexible Savings Account (FSA), a Healthcare Reimbursement Arrangement (HRA), a Medical Savings Account (MSA), and the like. That is, member P receives federal, state and/or local tax benefits on funds in such tax-advantaged account(s) 106. As is well known to one skilled in the art, both an employer and an employee can contribute funds to certain tax-advantaged accounts, specifically the HSA.

In general, member P draws funds from tax-advantaged account(s) 106 first and uses non-tax-advantaged account(s) 104 as secondary funding sources. Member P may further prioritize from which account (within non-tax-advantaged account(s) 104 and tax-advantaged account(s) 106) the funds will be drawn first. Further still, the amount of funds transferred can also be customized per individual needs of member P. As an example, consider a scenario where a member P plans to visit a healthcare provider (for example, a general physician) as a patient. Prior to the visit, member P may know an approximate cost for the visit (say, $100). However, tax-advantaged account(s) 106 contains only $80. Member P may then load the remaining $20 from non-tax-advantaged account(s) 104. As described earlier, this may be done from a web-portal, for example. Following such a loading operation, the transaction instrument associated with URA 102 (a healthcare card, for example) is ready to be used at the desired provider. Such a loading operation may be beneficial, for example, in avoiding a decline of service scenario.

Further still, member P may choose only one of non-tax-advantaged account(s) 104 and tax-advantaged account(s) 106 to fund a purchase. Additionally, the provider may have a valid Merchant Category Code (MCC) pre-recognized by the financial institution maintaining member P's various accounts. Further still, it will be readily apparent to one skilled in the art that although the example described herein is that of a healthcare/medical service provider, the system and process of loading funds from non-tax-advantaged account(s) 104 and tax-advantaged account(s) 106 into URA 102, and subsequently using those loaded funds via a transaction instrument is equally valid in other transaction scenarios, like a parking payment or any other purchased item, for example.

It should also be noted that although the term “Universal Rollover Account” is used herein to describe the various embodiments of the present invention, other terms like “Payment Account System”, “Payment Account”, and the like describe the present invention equally well.

Member P can be given rights to re-charge URA 102 when funds in URA 102 fall below a pre-defined threshold. In one embodiment, member P may choose to do so automatically on a regular basis or as and when needed. Alternatively, member P may be sent an alert about a threshold fund value via the web-portal, an e-mail, a message on a mobile device, a telephone call, a telephone banking operation (manual and/or automated), or the like.

According to one embodiment of the present invention, up to a total of 22 accounts (non-tax-advantaged account(s) 104 and tax-advantaged account(s) 106) may be used to fund URA 102 bucket, although this number is not meant as a limitation for the invention.

### III. Enrollment Process

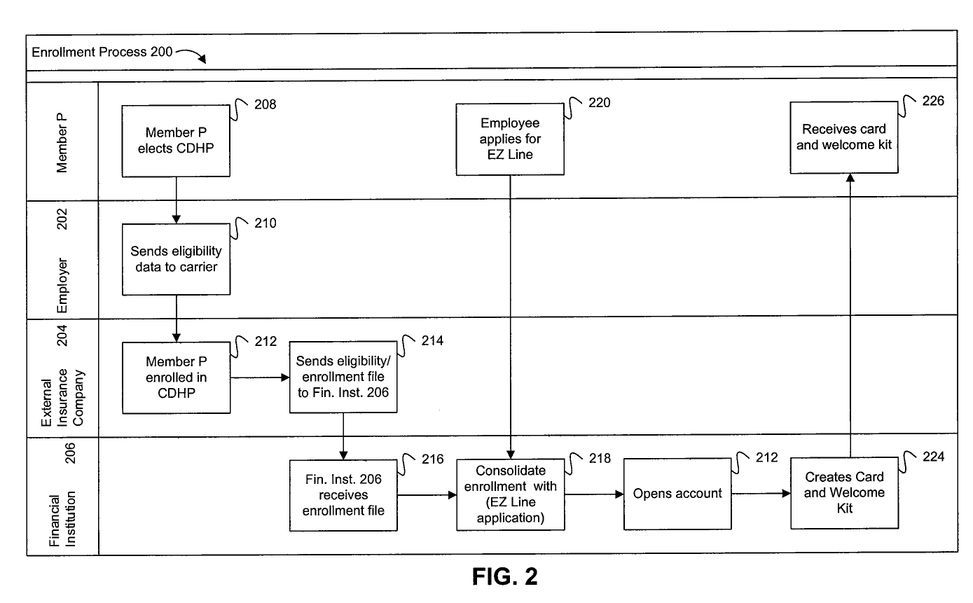

FIG. 2 is a flowchart illustrating an exemplary enrollment process 200 for a member P to enroll in URA system 100. Enrollment process 200 begins at step 208 when member P selects or chooses the CDHP he or she wants to be a part of. Although enrollment process 200 is described herein in terms of healthcare plans like CDHPs, it will be readily apparent to one skilled in the art that a similar enrollment process can be applied for other types of transactional scenarios where the present invention may be used. For example, URA system 100 may be used in a monthly membership plan for a car-park or a fitness center.

In step 210, after member P has selected a particular healthcare plan, he or she may be determined eligible to be enrolled in URA 102 by an employer 202. Employer 202 then sends the eligibility data to an external insurance company 204.

In step 212, insurance company 204 checks whether or not member P is an eligible member. It then passes on the eligibility check data and/or enrollment file to financial institution 206, in step 214.

In step 216, financial institution 206 receives the enrollment file and the eligibility data.

In step 218, financial institution 216 consolidates member P's enrollment information.

Alternatively, member P may directly apply for an account with financial institution 206 and then link it with URA 102, as shown in step 220. Once financial institution 206 has completed the consolidation of member P's enrollment, it opens member P's account, as shown is step 222. Subsequently, in step 224, financial institution 206 creates or activates a transaction instrument (or a card) and “Welcome Kit” comprising details about member benefits and sends it to member P.

Member P receives and activates the transaction instrument in step 226 after which the transaction instrument is ready to be used for various purchases.

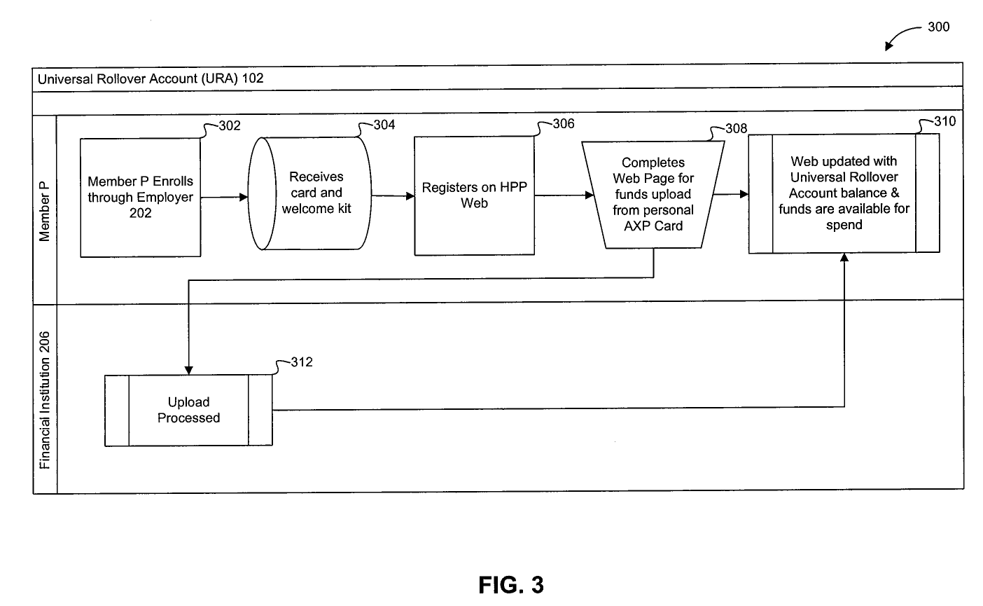

FIG. 3 depicts a flowchart 300 showing how member P can manage URA 102. In step 302 (similar to step 226 of FIG. 2), member P enrolls in URA 102 through employer 202.

After receiving a card (or generally, any transaction instrument) in step 304, member P registers for URA 102 via a web-portal, as shown in step 306.

In step 308, member P fills out information on the web-portal and can upload funds to the transaction instrument from another bank account and/or personal card. Such information can include, for example, member P's name, a card number, a membership expiry date, a card identification number (CID), and the like. As is also well known to one skilled in the art, any information pertaining to URA 102 can be stored in one or more databases described herein.

Once the step 308 of uploading funds is complete, member P can use these finds for spending and can monitor his or her expenses, as shown by step 310.

Information about transfer and upload of funds is then sent to financial institution 206 in step 312. Financial institution 206 processes the upload of funds and sends the update information back to the web-portal via a server on which the web-portal is hosted.

An exemplary transaction instrument could be a magnetic stripe card (to be used as a multi-purse card) containing different regions for storage of various data. The term “multi-purse card” refers generally to a transaction instrument which is used to load funds from different funding sources, as used herein. According to one embodiment of the invention, these regions may contain financial information, eligibility and other information related to member P. Also, the present invention is not limited in terms of its allocation of the type of information stored in these magnetic regions (also known as “tracks”). Further, as can be envisioned by those skilled in the art, the transaction instrument used in the current invention can be implemented by other forms of data storage and processing devices, like RFIDs, chip cards and the like.

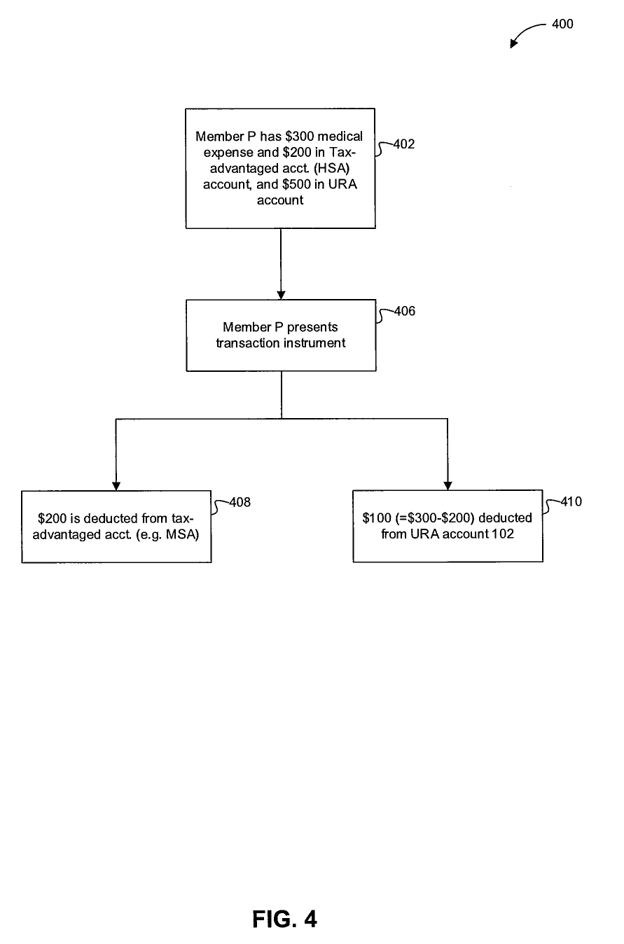

FIG. 4 shows an exemplary transaction flowchart 400 that member P may initiate. For example, member P may incur a charge of $300 as medical expenses at a provider (step 402).

Member P may then present the transaction instrument (which may be a magnetic stripe card as described above) in step 406. Such a transaction instrument may be read by a wireless bar-code reader, a wedge card-reader, or any other transaction instrument reading mechanism well known to those skilled in the art.

In step 408, $200 may then be withdrawn from member P's tax-advantaged accounts. The remaining balance of $100 is then withdrawn from URA 102. The amount of $100 may have been earlier loaded to URA 102 from a non-tax-advantaged funding source. It will be readily apparent to one skilled in the art that member P can prioritize or even choose from which non-tax-advantaged funding source(s) 104 to draw funds and use funds only from a chosen non-tax-advantaged funding source(s) 104. Additionally, member P may also choose to send any unused funds in URA 102 back to the account from which those funds initially originated.

### IV. Example Implementations

The present invention (i.e., system 100, process 200, flowchart 300, flowchart 400 or any part(s) or function(s) thereof) may be implemented using hardware, software or a combination thereof, and may be implemented in one or more computer systems or other processing systems. However, the manipulations performed by the present invention were often referred to in terms, such as comparing or checking, which are commonly associated with mental operations performed by a human operator. No such capability of a human operator is necessary, or desirable in most cases, in any of the operations described herein, which form a part of the present invention. Rather, the operations are machine operations. Useful machines for performing the operations in the present invention may include general-purpose digital computers or similar devices.

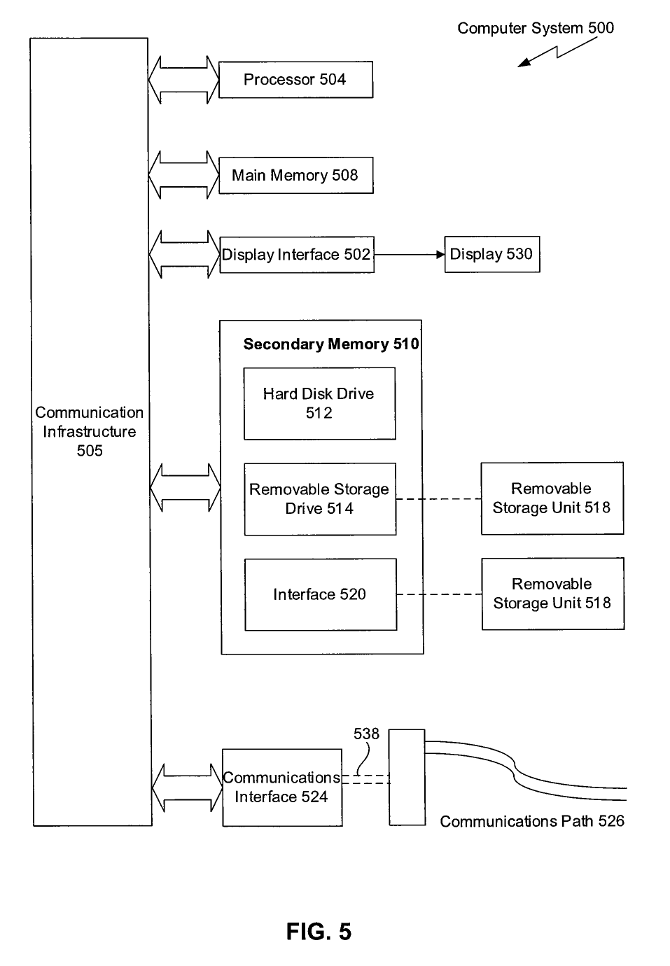

In fact, in accordance with an embodiment of the present invention, the present invention is directed towards one or more computer systems capable of carrying out the functionality described herein. An example of the computer systems includes a computer system 500, which is shown in FIG. 5.

Computer system 500 includes one or more processors, such as a processor 504. Processor 504 is connected to a communication infrastructure 506, for example, a communications bus, a cross over bar, a network, and the like. Various software embodiments are described in terms of this exemplary computer system 500. After reading this description, it will become apparent to a person skilled in the relevant art(s) how to implement the present invention using other computer systems and/or architectures.

Computer system 500 includes a display interface 502 that forwards graphics, text, and other data from communication infrastructure 506 (or from a frame buffer which is not shown in FIG. 6) for display on a display 530.

Computer system 500 also includes a main memory 508, such as random access memory (RAM), and may also include a secondary memory 510. Secondary memory 510 may include, for example, a hard disk drive 512 and/or a removable storage drive 514, representing a floppy disk drive, a magnetic tape drive, an optical disk drive, etc. Removable storage drive 514 reads from and/or writes to a removable storage unit 518 in a well known manner. Removable storage unit 518 represents a floppy disk, magnetic tape, optical disk, and the like. Removable storage unit 518 may be read by and written to by removable storage drive 514. As will be appreciated, removable storage unit 518 includes a computer usable storage medium having stored therein, computer software and/or data.

In accordance with various embodiments of the present invention, secondary memory 510 may include other similar devices for allowing computer programs or other instructions to be loaded into computer system 500. Such devices may include, for example, a removable storage unit such as removable storage unit 518, and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from removable storage unit 518 to computer system 500.

Computer system 500 may also include a communication interface 524. Communication interface 524 allows software and data to be transferred between computer system 500 and external devices. Examples of communication interface 524 may include a modem, a network interface (such as an Ethernet card), a communications port, a Personal Computer Memory Card International Association (PCMCIA) slot and card, and the like. Software and data transferred via communication interface 524 are in the form of a plurality of signals, hereinafter referred to as signals 538, which may be electronic, electromagnetic, optical or other signals capable of being received by communication interface 524. Signals 538 are provided to communication interface 524 via a communication path (e.g., channel) 526. Communication path 526 carries signals 538 and may be implemented using wire or cable, fiber optics, a telephone line, a cellular link, a radio frequency (RF) link and other communication channels.

In this document, the terms “computer program medium” and “computer usable medium” are used to generally refer to media such as removable storage drive 514, a hard disk installed in hard disk drive 512, signals 538, and the like. These computer program products provide software to computer system 500. The present invention is directed to such computer program products.

Computer programs (also referred to as computer control logic) are stored in main memory 508 and/or secondary memory 510. Computer programs may also be received via communication interface 524. Such computer programs, when executed, enable computer system 500 to perform the features of the present invention, as discussed herein. In particular, the computer programs, when executed, enable processor 504 to perform the features of the present invention. Accordingly, such computer programs represent controllers of computer system 500.

In accordance with an embodiment of the present invention, where the present invention is implemented using software, the software may be stored in a computer program product and loaded into computer system 500 using removable storage drive 514, hard disc drive 512 or communication interface 524. The control logic (software), when executed by processor 504, causes processor 504 to perform the functions of the present invention as described herein.

In another embodiment, the present invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the present invention is implemented using a combination of both the hardware and the software.

### V. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

1. A payment account system associated with a transaction instrument to pay for items purchased by a card member from a provider, comprising:
a tax-advantaged funding source to provide a first part of funds for payment to the provider using the transaction instrument; and
a non-tax-advantaged funding source to provide a second part of the funds for payment to the provider using the transaction instrument.

2. The payment account system of claim 1, wherein the transaction instrument is at least one of a multi-purse card and a healthcare card.

3. The payment account system of claim 1, wherein the payment account system is a universal rollover account system.

4. The payment account system of claim 1, wherein the tax-advantaged funding source is at least one of a Healthcare Savings Account (HSA), a Flexible Savings Account (FSA), a Healthcare Reimbursement Arrangement (HRA), and a Medical Savings Account (MSA).

5. The payment account system of claim 1, wherein the non-tax-advantaged funding source is at least one of a checking account, a line of credit account, a credit card account, an Automated Clearing House (ACH) account, a savings account and a debit card account.

6. The payment account system of claim 2, wherein the payment account system is manageable by the member via a web-portal.

7. The payment account system of claim 1, wherein the payment account is operable at a valid Merchant Category Code (MCC) provider.

8. A method of funding a payment account associated with a transaction instrument, comprising:
(a) loading funds from a tax-advantaged funding source into the payment account associated with the transaction instrument prior to a purchase of an item by a member;
(b) loading additional funds from a non-tax-advantaged funding source into the payment account associated with the transaction instrument prior to the purchase of the item by the member; and
(c) authorizing a payment for the purchased item up to a total amount of the funds available in the payment account.

9. The method of claim 8, further comprising:
(d) drawing funds from the tax-advantaged funding source to load the payment account before drawing the additional funds from the non-tax-advantaged funding source in payment for the purchased item.

10. The method of claim 9, further comprising:
(d) drawing all available funds in the tax-advantaged funding source to load the payment account before drawing the additional funds from the non-tax-advantaged funding source in the payment for the purchased item.

11. The method of claim 8, further comprising:
(d) storing data associated with the purchase of the item on a web-portal; and
(e) providing the member access to the non-tax-advantaged funding source to modify information on the web-portal.

12. The method of claim 8, further comprising:
(d) adding further additional funds from a funding source different from the tax-advantaged and the non-tax-advantaged funding source into the non-tax-advantaged funding source at regular and non-regular intervals as defined by the member.

13. (canceled)

14. The method of claim 8, wherein step (b) further comprises loading the additional funds when the total amount of the funds available in the combination of the tax-advantaged and non-tax-advantaged funding sources in the payment account falls below a pre-determined threshold value.

15. The method of claim 8, further comprising:
(d) configuring an order of selection of at least two separate funding sources that are non-tax-advantaged funding sources in payment for the purchased item based on the member's preference.

16. The method of claim 8, wherein the transaction instrument is a healthcare card.

17. The method of claim 8, wherein the payment account is at least one of a healthcare related account and a universal rollover account.

18. The method of claim 8, further comprising:
(d) enrolling the member into the payment account prior to step (a);
(e) updating the member's financial information;
(f) withdrawing funds from the payment account in payment for the purchase of the item by the member; and
(g) depositing unused funds in the payment account, after completing the purchase, back into at least one of the tax-advantaged and the non-tax-advantaged funding source.

19. (canceled)

20. The method of claim 18, wherein step (e) further comprises entering on a web-portal at least one of (1) the member's name, (2) a member card number, (3) the member's membership expiry date and (4) a card identification (CD) number.

21. The method of claim 8, wherein at least one of steps (a) and (b) can be accomplished using a telephone banking system.

22. A method for processing a healthcare related purchase, comprising:
(a) enrolling a card member into a universal rollover account;
(b) updating the card member's financial information;
(c) linking the universal rollover account to at least one of a tax-advantaged and a non-tax-advantaged funding source;
(d) loading funds into the universal rollover account; and
(e) withdrawing the funds from the universal rollover account to pay for a healthcare item purchased by the card member.

23. The method of claim 22, further comprising:
(f) depositing unused funds in the universal rollover account, following a completion of the healthcare related purchase, back into at least one of the tax-advantaged and the non-tax-advantaged funding source.

24. (canceled)

25. The method of claim 22, wherein step (b) further comprises entering on a web-portal at least one of (1) the card member's name, (2) the card member's card number, (3) the card member's card expiry date and (4) a card identification (CD) number.

26. The method of claim 22, wherein step (d) can be accomplished using a telephone banking system.

27. A computer program product comprising a computer usable medium having control logic stored therein for causing a computer to maintain a card member's universal healthcare rollover account bucket, said control logic comprising:
computer readable program code containing a set of instructions for enrolling the card member via a web-portal;
computer readable program code for linking the universal rollover account bucket to a tax-advantaged funding source database;
computer readable program code for linking the universal rollover account bucket to a non-tax-advantaged funding source database; and
computer readable code for causing the computer to load the universal rollover account bucket with funds from at least one of (1) the tax-advantaged funding source database and (2) the non-tax-advantaged funding source database.

28. The computer program product code of claim 27, further comprising:
computer program product code for updating information related to the card member's tax-advantaged funding source database and non-tax-advantaged funding source database after a payment for a healthcare item purchased by the card member from a provider.
